(19) United States
(12) Patent Application Publication
(10) Pub. No.: US 2013/0247677 A1
(43) Pub. Date: Sep. 26, 2013

(54) PRESSURE SENSOR

(71) Applicant: SEIKO INSTRUMENTS INC., Chiba (JP)

(72) Inventors: Takeshi UCHIYAMA, Chiba (JP); Masataka SHINOGI, Chiba (JP)

(73) Assignee: SEIKO INSTRUMENTS INC., Chiba (JP)

(21) Appl. No.: 13/779,863

(22) Filed: Feb. 28, 2013

(30) Foreign Application Priority Data
Mar. 8, 2012 (JP) 2012-051471

(51) Int. Cl. G01L 13/02

(52) U.S. Cl. CPC G01L 13/02
USPC 73/721; 73/717

(57) ABSTRACT

A pressure sensor includes a detecting circuit configured to detect the difference between outputs from a first pressure variation sensor and a second pressure variation sensor. The first pressure variation sensor and the second pressure variation sensor have the same distance of a gap, and have frequency characteristics different from each other, that is, cutoff frequencies different from each other by setting the value of a capacity of the cavity of the first pressure variation sensor to be larger than the value of a capacity of the cavity of the second pressure variation sensor.

### BACKGROUND OF THE INVENTION

1. Technical Field

The present invention relates to a pressure sensor.

2. Description of the Related Art

In the related art, for example, a differential pressure sensor (pressure sensor) including two pressure sensor elements of both-side pressure receiving type arranged in the proximity of two symmetrical positions on a pressure introducing route so as to have reverse polarities from each other, and configured to amplify differential of outputs from both of the pressure sensor elements, thereby obtaining an output from which a detection error due to temperature characteristics of the pressure sensor elements and vibrations caused by disturbance are compensated is known (for example, see JP-A-4-29027).

Incidentally, if the pressure sensor of the related art described above has, for example, a gentle or no frequency dependency of sensitivity with respect to the pressure in accordance with the shape and material of the sensing portion, and has a sensitivity substantially equivalent to a wide range of frequency band, a noise (sound) caused by signals in other frequency bands may increase with respect to signals in a desired frequency band, so that there is a risk of saturation of the output from the pressure sensor due to the signals other than the desired frequency band.

### SUMMARY

In view of such circumstances, it is an object of the invention to provide a pressure sensor configured to be capable of obtaining desired frequency characteristics while reducing detection errors and vibrations due to disturbance.

In order to solve the problem described above and achieve the object described above, there is provided a pressure sensor includes: two pressure variation sensors (for example, a first pressure variation sensor (P1) 11a and a second pressure variation sensor (P2) 11b of the embodiment), and a detecting unit configured to detect the difference between outputs from the two pressure variation sensors (for example, a detection circuit 12 of the embodiment), the pressure variation sensors each includes: an opening cavity (for example, a cavity 21 of the embodiment); a cantilever (for example, a cantilever 22 of the embodiment) formed into a plate shape extending from a proximal side toward a distal side, including a proximal end portion (for example, a proximal end portion 22a of the embodiment) supported in a cantilevered state at an opening end (for example, an opening end 21a of the embodiment) of the cavity and a distal end portion (for example, a distal end portion 22b of the embodiment) as a free end and configured to be subject to a flexural deformation in accordance with the pressure difference between the interior and the exterior of the cavity; a gap (for example, a gap 23 of the embodiment) provided between the distal end portion of the cantilever and the opening end of the cavity and configured to communicate the interior and the exterior of the cavity; and a deformation detecting unit (for example, a piezoresistance of the embodiment) configured to detect a flexural deformation of the cantilever and output a signal of a result of detection, wherein the two pressure variation sensors have frequency characteristics different from each other in accordance at least with the capacities of the cavities or the distance of the gaps.

In addition, according to the pressure sensor of the invention, the frequency characteristic is a lower limit frequency which provides the sensitivities of the pressure variation sensors equal to or higher than a predetermined value.

Furthermore, according to the pressure sensor of the invention, the two pressure variation sensors are arranged so as to be adjacent with the distal end portion of one of the cantilevers and the proximal end portion of the other cantilever faced each other in the direction of extension of the cantilevers.

Still further, according to the pressure sensor of the invention, the two pressure variation sensors are arranged so as to be adjacent with the distal end portions of the cantilevers faced each other in the direction of extension of the cantilevers.

In addition, according to the pressure sensor of the invention, the deformation detecting unit includes a piezoresistance (for example, a piezoresistance 24 of the embodiment) formed by doping impurity at the proximal end portion of the cantilever formed of a semiconductor material.

According to the pressure sensor of the invention, by detecting the difference of the output from the two pressure variation sensors having frequency characteristics different from each other, only the pressure variation having desired frequency characteristics corresponding to the difference in different frequency characteristics may be detected.

Accordingly, increase in noise (sound) with respect to the pressure variations in the desired frequency characteristics due to the pressure variations in other frequency characteristics other than the desired frequency characteristics is prevented, and saturation of the signal in the amplifying circuit of the first step is prevented.

In addition, the detection error due to the temperature characteristic or vibrations due to the disturbance generated in the pressure variation sensors may be compensated by the difference in output from the two pressure variation sensors, so that the detection accuracy of the pressure variations may be improved.

Furthermore, only the pressure variations in the desired frequency band corresponding to the difference between different lower limit frequencies may be detected by setting the frequency characteristics of the two pressure variation sensors different from each other to, for example, lower limit frequencies which provide the sensitivities of the pressure variation sensor equal to or higher than the predetermined value such as the cutoff frequency.

In other words, the pressure variations at higher frequencies and lower frequencies with respect to the desired frequency band between one of the lower limit frequencies and the other lower limit frequency may be compensated by detecting the difference between the outputs from the two pressure variation sensors.

Accordingly, the pressure sensor may be operated so as to have the sensitivity only for the pressure variations in so-called a desired frequency band.

Furthermore, the two pressure variation sensors are arranged so that the cantilevers extend in the same direction from the proximal ends to the distal ends of the respective cantilevers in the direction of extension of the cantilevers, whereby the cantilevers are subject to the action of the vibrations caused by the disturbance such as wind or light evenly. Therefore, the vibrations caused by the disturbance generated in the two pressure variation sensors respectively may be compensated adequately by the difference in outputs from the two pressure variation sensors.

Furthermore, the two pressure variation sensors are arranged so that the cantilevers extend in the opposite directions from the proximal ends to the distal ends of the respective cantilevers in the direction of extension of the cantilevers, whereby generation of phase difference in sensitivities of the cantilevers may be inhibited with respect to vibrations of a high frequency band such as a sound. Therefore, the vibrations in the high frequency band such as the sound generated in the respective pressure variation sensors may be compensated by the difference between the outputs from the two pressure variation sensors.

### BRIEF DESCRIPTION OF THE DRAWINGS

FIGS. 1A and 1B are a plan view and a cross-sectional view of a pressure variation sensor of a pressure sensor according to an embodiment of the invention;

FIGS. 2A and 2B are graphs showing an example of an output from the pressure variation sensor of the pressure sensor according to the embodiment of the invention;

FIGS. 3A to 3C are drawings illustrating an example of an action of the pressure variation sensor of the pressure sensor according to the embodiment of the invention;

FIG. 4 is a configuration diagram of the pressure sensor according to the embodiment of the invention;

FIG. 5 is a configuration diagram of the pressure sensor according to the embodiment of the invention;

FIGS. 6A and 6B are graphs showing an example of an output from the pressure sensor according to the embodiment of the invention;

FIG. 7 is a configuration diagram of the pressure sensor according to a first modification of the invention;

FIG. 8 is a configuration diagram of the pressure sensor according to a second modification of the invention;

FIGS. 9A and 9B are a plan view and a cross-sectional view of the pressure sensor according to a third modification of the invention; and

FIGS. 10A and 10B are a plan view and a cross-sectional view of the pressure sensor according to a fourth modification of the invention.

### DESCRIPTION OF THE PREFERRED EMBODIMENTS

Referring now to the drawings, a pressure sensor according to an embodiment of the invention will be described.

A pressure sensor 10 of the embodiment includes two pressure variation sensor 11 (for example, a first pressure variation sensor (P1) 11a and a second pressure variation sensor (P2) 11b) having frequency characteristics different from each other, and a detection circuit 12 configured to detect the difference between outputs from the two pressure variation sensors 11. The pressure sensor 10 outputs a signal according to variations in pressure (for example, atmospheric pressure or the like).

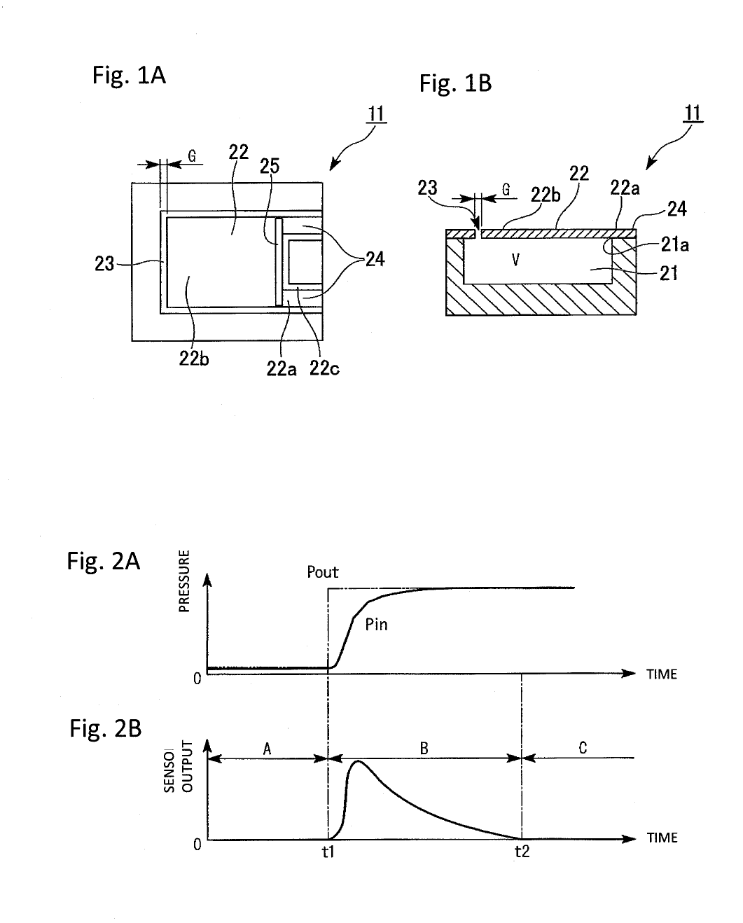

The pressure variation sensor 11 of the pressure sensor 10 is formed of an SOI substrate obtained by thermally sticking a silicon supporting layer, an oxidized layer formed of SiO₂, and a silicon active layer. For example, as illustrated in FIGS. 1A and 1B, the pressure variation sensor 11 of the pressure sensor 10 includes a cavity 21, a cantilever 22, a gap 23, and piezoresistances 24.

The cavity 21 is formed into a bottomed cylindrical shape with an opening using, for example, the silicon supporting layer of the SOI substrate.

The cantilever 22 is formed into a plate shape extending in the direction from a proximal end side toward a distal end side (longitudinal direction) using the silicon active layer of the SOI substrate, includes a proximal end portion 22a supported at an opening end 21a of the cavity 21 in a cantilevered manner and a distal end portion 22b having a free end, and is subject to a flexural deformation in accordance with the pressure difference between the interior and the exterior of the cavity 21.

The gap 23 is provided between the distal end portion 22b of the cantilever 22 and the opening end 21a of the cavity 21, and communicates the interior and the exterior of the cavity 21.

The piezoresistances 24 are formed by a doping agent (impurity) such as phosphorus doped on the proximal end portion 22a of the cantilever 22 by various methods such as an ion implantation method or a diffusion method, is provided so as to sandwich a through hole 22c penetrating the proximal end portion 22a of the cantilever 22 in the thickness direction from both sides in the short direction (the direction orthogonal to the longitudinal direction and the thickness direction of the cantilever 22), and varies the resistance value in accordance with the deformation amount of the flexural deformation of the cantilever 22 (that is, the magnitude of the stress).

The one and the other piezoresistances 24 provided on the both sides of the through hole 22c are connected to the detection circuit 12 described later, and a wiring portion 25 formed of a conductive material and provided at a position shifted toward the distal end side from the through hole 22c at the proximal end portion 22a of the cantilever 22, and a general shape including the wiring portion 25 and the one and the other piezoresistances 24 is formed into a U-shape in plan view.

Accordingly, for example, when a predetermined voltage is applied to one of the piezoresistances 24, a current caused by the voltage application run around the through hole 22c and flows by way of one of the piezoresistances 24 through the wiring portion 25 to the other piezoresistance 24. This current corresponds to an output from the pressure variation sensor 11 varied in magnitude in accordance with the resistance value of the piezoresistance 24 varying in accordance with the amount of the flexural deformation of the cantilever 22.

The pressure variation sensor 11 has specific frequency characteristics in accordance at least with the capacity V of the cavity 21 or the distance G of the gap 23.

The frequency characteristics is a lower limit frequency having a sensitivity of the pressure variation sensor 11 equal to or higher than the predetermined value such as a cutoff frequency fc, for example, and the sensitivity has a decreasing tendency in association with the lowering of the frequency with respect to pressure variations in a frequency band lower than the lower limit frequency and the sensitivity is changed to have an increasing tendency from the predetermined value so as to be saturated to the upper limit value in association with the increase in frequency with respect to the pressure variations in the frequency band higher than the lower limit frequency.

An operation example of the pressure variation sensor 11 will be given below.

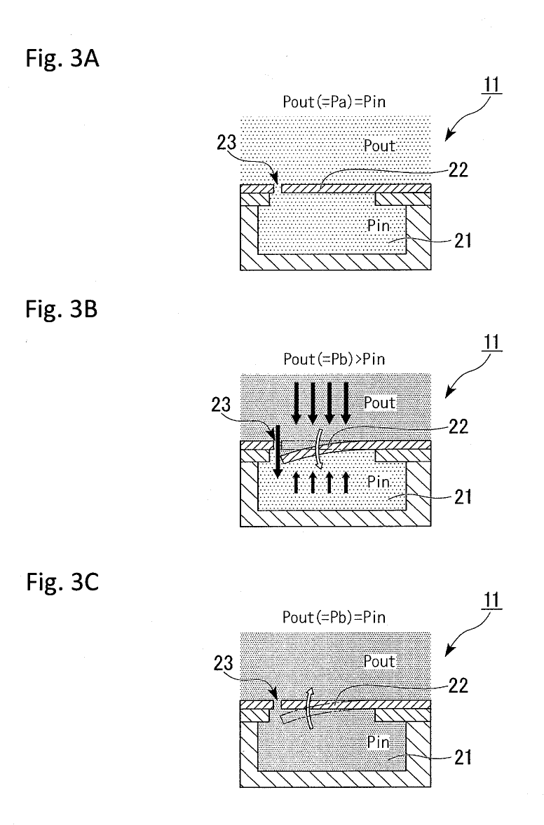

In the pressure variation sensor 11, for example, when the pressure difference between a pressure Pout (first predetermined pressure Pa) on the exterior of the cavity 21 and a pressure Pin on the interior of the cavity 21 is zero as in a period A shown in FIGS. 2A and 2B, the cantilever 22 is not subject to the flexural deformation and the output from the pressure variation sensor 11 (the sensor output) is zero, for example, as illustrated in FIG. 3A.

In contrast, for example, as a period B from the time-of-day t1 shown in FIGS. 2A and 2B, when the outer pressure Pout of the cavity 21 is increased step by step (Pout←second predetermined pressure Pb>Pa), the cantilever 22 starts the flexural deformation in accordance with the pressure difference between the exterior and the interior of the cavity 21, for example, as illustrated in FIG. 3B, and the output from the pressure variation sensor 11 is changed to the increasing tendency in association with the increase in this deformation amount.

Then, when a pressure transmission medium flows from the exterior to the interior of the cavity 21 via the gap 23 and the pressure Pin on the interior of the cavity 21 is increased gradually in a gentler response than the variations of the pressure Pout on the exterior thereof, the deformation amount of the cantilever 22 is changed to have a decreasing tendency in association with the decrease in the pressure difference between the exterior and the interior of the cavity 21, and hence the output from the pressure variation sensor 11 is changed to have a decreasing tendency.

Then, for example, when the pressure Pin in the interior of the cavity 21 is equal to the pressure Pout on the exterior thereof as a period C from a time-of-day t2 onward as shown in FIGS. 2A and 2B (Pin=Pout=Pb), the flexural deformation of the cantilever 22 is released as illustrated in FIG. 3C, and the output from the pressure variation sensor 11 becomes zero.

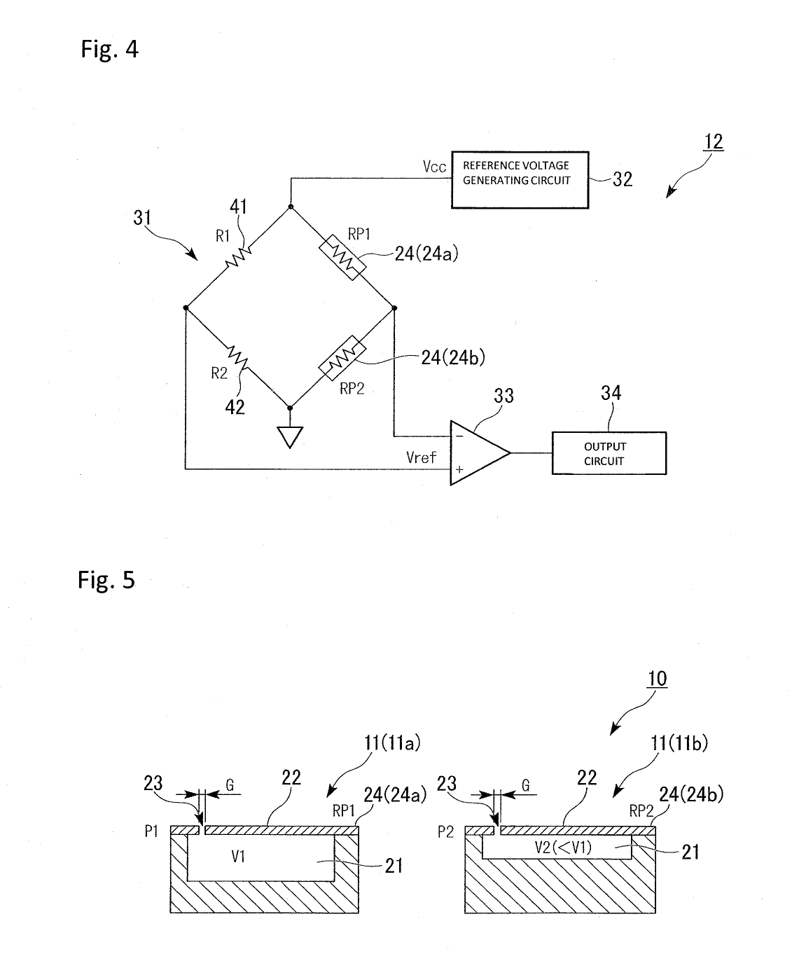

The detection circuit 12 of the pressure sensor 10 includes a bridge circuit 31, a reference voltage generating circuit 32, a differential amplifying circuit 33, and an output circuit 34 as illustrated in FIG. 4 for example.

The bridge circuit 31 includes a branch portion including the piezoresistance 24 of the first pressure variation sensor (P1) 11a (first piezoresistance 24a: resistance value RP1) and the piezoresistance 24 (second piezoresistance 24b: resistance value RP2) of the second pressure variation sensor (P2) 11b connected in series and a branch portion including a fixed resistance 41 (resistance value R1) and a fixed resistance 42 (resistance value R2) connected in series, and these branches are connected in parallel to the reference voltage generating circuit 32.

In the bridge circuit 31, a connecting point between the first piezoresistance 24a and the second piezoresistance 24b is connected to an inverting input terminal of the differential amplifying circuit 33, and a connecting point between the fixed resistances 41 and 42 is connected to a non-inverting input terminal of the differential amplifying circuit 33.

The reference voltage generating circuit 32 applies a predetermined reference voltage Vcc to the bridge circuit 31.

The differential amplifying circuit 33 detects a potential difference between connecting point between the fixed resistances 41 and 42 of the bridge circuit 31 and a connecting point between the first piezoresistance 24a and the second piezoresistance 24b, and the potential difference is amplified in a predetermined gain before outputting therefrom.

The potential difference corresponds to the difference between the resistance value RP1 of the first piezoresistance 24a and the resistance value RP2 of the second piezoresistance 24b (RP1−RP2), that is, a value in accordance with the difference between the output from the first pressure variation sensor (21) 11a and the output from the second pressure variation sensor (P2) 11b.

As illustrated in FIG. 5, the first pressure variation sensor (P1) 11a and the second pressure variation sensor (P2) 11b have the same distance G of the gap 23, and have frequency characteristics different from each other, that is, cutoff frequencies fc1 and fc2 (>fc1) different from each other by setting the value of a capacity V1 of the cavity 21 of the first pressure variation sensor (P1) 11a to be larger than the value of a capacity V2 of the cavity 21 of the second pressure variation sensor (P2) 11b.

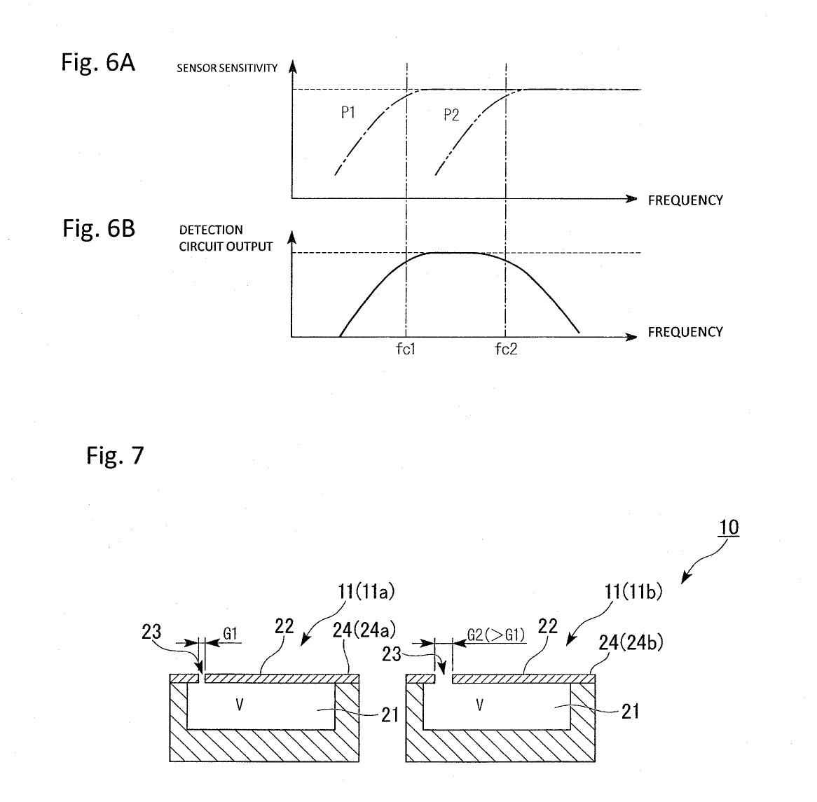

Accordingly, as shown in FIGS. 6A and 6B, the first pressure variation sensor (P1) 11a demonstrates a sensitivity equal to or higher than the predetermined value in the frequency band equal to or higher than the cutoff frequency fc1 and the second pressure variation sensor (P2) 11b demonstrates a sensitivity equal to or higher than the predetermined value in the frequency band equal to or higher than the cutoff frequency fc2 than that of the cutoff frequency fc1, so that the difference between the output from the first pressure variation sensor (P1) 11a and the output from the second pressure variation sensor (P2) 11b compensates the output in the frequency band other than the frequency band (fc2−fc1) between the different cutoff frequencies fc1 and f2.

Therefore, the pressure sensor 10 acts so as to have the sensitivity only for the pressure variations in so-called a desired frequency band (fc2−fc1).

The output circuit 34 includes, for example, a low-pass filter, and performs a predetermined filtering process on a signal output from the differential amplifying circuit 33, and outputs the signal after the process.

As described above, the pressure sensor 10 of the embodiment is capable of detecting only the pressure variations in the desired frequency band corresponding to the difference between the different lower limit frequencies by detecting the difference between the outputs from the two pressure variation sensors 11 (the first pressure variation sensor (P1) 11a and the second pressure variation sensor (P2) 11b) having the lower limit frequencies which provides the sensitivity of the pressure variation sensor 11 equal to or higher than the predetermined value such as the cutoff frequency.

Accordingly, increase in noise (sound) with respect to the pressure variations in the desired frequency band due to the pressure variations in other frequency bands other than the desired frequency band is prevented, and saturation of the signal in the amplifying circuit of the first step is prevented.

In addition, the detection error due to the temperature characteristic or vibrations due to the disturbance generated in the first pressure variation sensor (P1) 11a and the second pressure variation sensor (P2) 11b may be compensated by the difference in output from the two pressure variation sensors 11, so that the detection accuracy of the pressure variations may be improved.

In the embodiment described above, as in a first modification illustrated in FIG. 7, for example, the capacities V of the cavities 21 of the first pressure variation sensor (P1) 11a and the second pressure variation sensor (P2) 11b may have the frequency characteristics different from each other and the cutoff frequencies fc1 and f2 (>fc1) different from each other by setting the capacities V of the cavities 21 to be the same and setting a distance G1 of the gap 23 of the first pressure variation sensor (P1) 11a to be smaller than a distance G2 of the gap 23 of the second pressure variation sensor (P2) 11b.

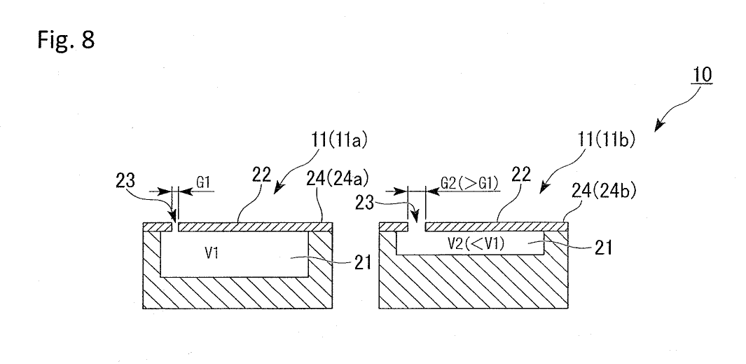

In the embodiment described above, as a second modification illustrated in FIG. 8, for example, the first pressure variation sensor (P1) 11a and the second pressure variation sensor (P2) 11b may have frequency characteristics different from each other, for example, the cutoff frequencies fc1 and f2 (>fc1) different from each other by setting the distance G1 of the gap 23 of the first pressure variation sensor (P1) 11a to be smaller than the distance G2 of the gap 23 of the second pressure variation sensor (P2) 11b, and setting the capacity V1 of the cavity 21 of the first pressure variation sensor (P1) 11a to be larger than the capacity V2 of the cavity 21 of the second pressure variation sensor (P2) 11b.

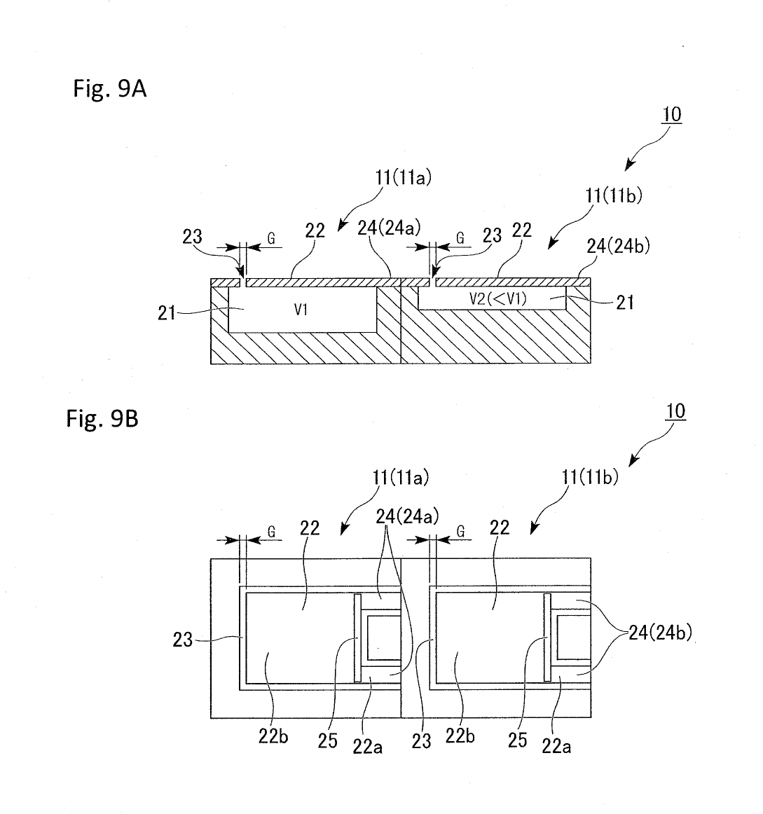

In the embodiments described above, the first pressure variation sensor (P1) 11a and the second pressure variation sensor (P2) 11b may be arranged adjacent to each other with the proximal end portion 22a of the cantilever 22 of the first pressure variation sensor (P1) 11a and the distal end portion 22b of the cantilever 22 of the second pressure variation sensor (P2) 11b faced each other in the direction of extension of the cantilevers 22 (longitudinal direction) for example, as a third modification illustrated in FIGS. 9A and 9B.

According to the third modification, the first pressure variation sensor (P1) 11a and the second pressure variation sensor (P2) 11b are arranged so that the cantilevers 22 extend in the same direction from the proximal ends to the distal ends of the respective cantilevers 22 in the direction of extension of the cantilevers 22, whereby the cantilevers 22 are subject to the action of the vibrations caused by the disturbance such as wind or light evenly. Therefore, the vibrations caused by the disturbance generated in the first pressure variation sensor (P1) 11a and the second pressure variation sensor (P2) 11b respectively may be compensated adequately by the difference in outputs from the first pressure variation sensor (P1) 11a and the second pressure variation sensor (P2) 11b.

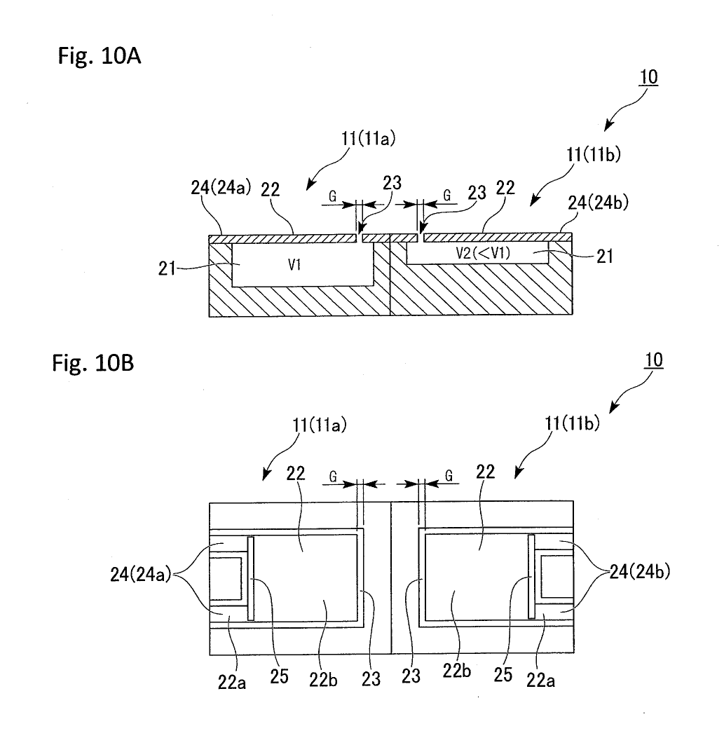

In the embodiment described above, as in a fourth modification shown in FIGS. 10A and 10B, the first pressure variation sensor (P1) 11a and the second pressure variation sensor (P2) 11b may be arranged adjacent to each other with the distal end portions 22b of the cantilevers 22 thereof faced to each other in the direction of extension (longitudinal direction) of the cantilevers 22.

According to the fourth modification, the first pressure variation sensor (P1) 11a and the second pressure variation sensor (P2) 11b are arranged so that the cantilevers 22 extend in the opposite direction from the proximal ends to the distal ends of the respective cantilevers 22 in the direction of extension of the cantilevers 22, whereby occurrence of phase difference in sensitivities of the cantilevers 22 due to the vibrations in a high frequency band such as sound may be inhibited. Therefore, the vibrations in the high frequency band such as sound generated in the first pressure variation sensor (P1) 11a and the second pressure variation sensor (P2) 11b respectively may be compensated adequately by the difference in outputs from the first pressure variation sensor (P1) 11a and the second pressure variation sensor (P2) 11b.

In the embodiment described above, the pressure sensor 10 includes the two pressure variation sensors 11 having frequency characteristics different from each other. However, the invention is not limited thereto, and a configuration in which at least a plurality of pressure variation sensors 11 are provided and the difference of the outputs from adequate two of the pressure variation sensors 11 therefrom may be detected.

In the embodiments described above, the pressure variation sensors 11 each have the specific frequency characteristics in accordance with the capacity V of the cavity 21 or the distance G of the gap 23. However, the invention is not limited thereto, and may have the specific frequency characteristics in accordance with the other parameters, such as the shape of the cavity 21 and the shape and the position of the gap 23, for example.

What is claimed is:

1. A pressure sensor comprising:
a first pressure variation sensor and a second pressure variation sensor;
the first pressure variation sensor and the second pressure variation sensor each including:
a cavity formed of an opening;
a cantilever formed into a plate shape extending in a direction from a proximal end to a distal end thereof, includes a proximal end portion supported at an opening end of the cavity in a cantilevered manner and a distal end portion as a free end, and is configured to be subject to a flexural deformation in accordance with a pressure difference between the interior and the exterior of the cavity;
a gap provided between the distal end portion of the cantilever and the opening end of the cavity configured to communicate the interior and the exterior of the cavity;
a deformation detecting unit configured to detect a flexural deformation of the cantilever and output a signal of a result of detection; and
a detecting unit configured to detect the difference between outputs from the first pressure variation sensor and the second pressure variation sensor, wherein
the first pressure variation sensor and the second pressure variation sensor have frequency characteristics different from each other in accordance at least with the capacity of the cavity and the distance of the gap thereof.

2. The pressure sensor according to claim 1, wherein the frequency characteristics are characteristics of a lower limit frequency which provides the sensitivities of the first pressure variation sensor and the second pressure variation sensors equal to or higher than a predetermined value.

3. The pressure sensor according to claim 1, wherein the first pressure variation sensor and the second pressure variation sensor are arranged so as to be adjacent to each other with the distal end portion of one of the cantilevers and the proximal end portion of the other cantilever faced each other in the direction of extension of the cantilevers.

4. The pressure sensor according to claim 1, wherein the first pressure variation sensor and the second pressure variation sensor are arranged so as to be adjacent to each other with the distal end portions of the cantilevers faced each other in the direction of extension of the cantilevers.

5. The pressure sensor according to claim 1, wherein the deformation detecting unit includes:
a piezoresistance formed by doping impurity at the proximal end portion of the cantilever formed of a semiconductor material.
